(19) United States
(12) Patent Application Publication
(10) Pub. No.: US 2024/0271741 A1
(43) Pub. Date: Aug. 15, 2024

(54) HEAT INSULATION AND REJECTION PROTECTOR

(71) Applicants: WTL Technology Shenzhen CO., LTD., Shenzhen (CN); SCOOCH, LLC, Noblesville, IN (US)

(72) Inventor: Tak Nam LIU, Shenzhen (CN)

(73) Assignees: WTL Technology Shenzhen CO., LTD., Shenzhen, GD (CN); SCOOCH, LLC, Noblesville, IN (US)

(21) Appl. No.: 18/144,250

(22) Filed: May 8, 2023

(30) Foreign Application Priority Data
Feb. 15, 2023 (CN) 202310140047.7

(51) Int. Cl. F16L 59/02; B32B 7/12; B32B 27/06; B32B 27/36; H04B 1/3888

(52) U.S. Cl. CPC F16L 59/029; B32B 7/12; B32B 27/065; B32B 27/36; H04B 1/3888; B32B 2250/05; B32B 2266/12; B32B 2307/304; B32B 2307/536; B32B 2307/7376; B32B 2571/00

(57) ABSTRACT

The present disclosure provides a heat insulation and rejection protector, including a protector main body, wherein a silica gel layer is arranged on an outer wall of a bottom portion of the protector main body, a sunlight rejection polyethylene terephthalate (PET) layer is arranged on an outer wall of one side of the silica gel layer, an optical clear adhesive (OCA) layer is arranged on an outer wall of one side of the sunlight rejection PET layer, a silkscreen layer is arranged on an outer wall of one side of the OCA layer, a glass board layer is arranged on an outer wall of one side of the silkscreen layer.

### CROSS REFERENCE

This application is based upon and claims priority benefits to Chinese Patent Application No. 202310140047.7, filed on Feb. 15, 2023, the contents of which are incorporated herein by reference.

### TECHNICAL FIELD

The present disclosure relates to the technical field of mobile phone accessories, specifically to a heat insulation and rejection protector.

### BACKGROUND

A mobile phone protector is also referred to as a mobile phone decorating protector. It is a cold-mounted protector that can be mounted on a surface of a mobile phone body, a mobile phone screen, and other tangible objects. There are various kinds of mobile phone protectors, which can include a mobile phone screen protector and a mobile phone body protector according to their uses. Initial simple anti-scratch protectors are improved to a functional protector series, including a peep-proof protector, a protector with a mirror function, an AR protector, a frosted protector, a high-definition protector, an anti-scratch protector, a 3D protector, a mobile phone body anti-scratch protector, a diamond protector, a tempered glass protector and the like. The mobile phone protector is an important accessory of a mobile phone.

However, the structure of the existing mobile phone protector on the market is relatively simple and does not have good heat insulation, so that the mobile phone is easily damaged at a high temperature in the later stage under the sunlight. The traditional mobile phone protector is not provided with a cushioning rubber edge structure, so the mobile phone protector is easy to break. There is no cylindrical leveling bubble structure, so that the protector does not have a function of leveling. Therefore, improvements are made, and a heat insulation and rejection protector is provided.

### SUMMARY

The present disclosure aims at the problem that an existing mobile phone protector does not have good heat insulation, so that a mobile phone is easily damaged at a high temperature in the later stage under the sunlight, and the problem that the traditional mobile phone protector is not provided with a cushioning rubber edge structure, so the mobile phone protector is easy to break.

In order to achieve the foregoing invention objective, the present disclosure provides the following technical solution:

A heat insulation and rejection protector is provided to solve the above problems.

The present disclosure is specifically below:

The heat insulation and rejection protector includes a protector main body: a silica gel layer is arranged on an outer wall of a bottom portion of the protector main body: a sunlight rejection polyethylene terephthalate (PET) layer is arranged on an outer wall of one side of the silica gel layer: an optical clear adhesive (OCA) layer is arranged on an outer wall of one side of the sunlight rejection PET layer: a silkscreen layer is arranged on an outer wall of one side of the OCA layer: a glass board layer is arranged on an outer wall of one side of the silkscreen layer; and an AF hardness layer is arranged on an outer wall of the glass board layer.

As a preferable technical solution of the present disclosure, the sunlight rejection PET layer includes a PET polyester substrate layer arranged at a middle portion of the protector main body: a fixed viscose layer, an anti-oxidization isolation layer and an anti-wear coating layer are arranged on an outer wall of one side of the PET polyester substrate layer in sequence: the outer wall of one side of the PET polyester substrate layer is covered with a plurality of metal heat insulation film layers; and an anti-ultraviolet isolation layer, a pressure-sensitive type viscose layer and a transparent membranous protective layer are arranged on an outer wall of one side of the metal heat insulation film layer in sequence.

As a preferable technical solution of the present disclosure, a thickness of the silica gel layer is 45 um: a thickness of the sunlight rejection PET layer is 50 um: a thickness of the OCA layer is 80 um/350 um: a thickness of the silkscreen layer is 8 um: a thickness of the glass board layer is 0.33/0.25 mm; and a thickness of the AF hardness layer is 5 um.

As a preferable technical solution of the present disclosure, a cushioning rubber edge is adhered to a peripheral outer wall of the protector main body.

As a preferable technical solution of the present disclosure, cylindrical level bubbles are inlaid in outer walls of two sides of the cushioning rubber edge.

Compared with the prior art, the present disclosure has the following beneficial effects:

In the solutions of the present disclosure:

The heat insulation and rejection protector has a better infrared rejection effect while maintaining good light transmittance, and has a better heat insulation characteristic compared to the traditional protector. The cushioning rubber edge arranged around the protector effectively prevents the mobile phone protector from being broken due to its elastic support when a mobile phone falls down. The cylindrical leveling bubbles play a role in horizontal calibration during a bonding process of the mobile phone protector. After the mobile phone is bonded to the protector, the mobile phone has a horizontal measurement function. During the use of the mobile phone, floating of bubbles in the cylindrical leveling bubbles achieves a certain decorating effect.

### BRIEF DESCRIPTION OF THE DRAWINGS

FIG. 1 is a schematic diagram of a three-dimensional structure of a heat insulation and rejection protector provided in the present disclosure;

FIG. 2 is a schematic diagram of a sectional structure of a heat insulation and rejection protector provided in the present disclosure:

FIG. 3 is a schematic diagram of a sectional structure of a sunlight rejection PET layer in the heat insulation and rejection protector provided in the present disclosure; and

FIG. 4 is a structural enlarged diagram of a region A in a heat insulation and rejection protector provided in the present disclosure.

### NUMERALS IN THE DRAWINGS

1: protector main body; 2: silica gel layer; 3: sunlight rejection PET layer; 4: OCA layer; 5: silkscreen layer; 6: glass board layer; 7: AF hardness layer; 8: cushioning rubber edge; 9; cylindrical leveling bubble;
301: PET polyester substrate layer; 302: fixed viscose layer; 303: anti-oxidization isolation layer; 304: anti-wear coating layer; 305: metal heat insulation film layer; 306: anti-ultraviolet isolation layer; 307: pressure-sensitive viscose layer; and 308: transparent membranous protective layer.

### DETAILED DESCRIPTION OF THE EMBODIMENTS

In order to make the objectives, technical solutions and advantages of the embodiments of the present disclosure clearer, the technical solutions in the embodiments of the present disclosure are described clearly and completely below in conjunction with the drawings. Obviously, the described embodiments are a part of the embodiments of the present disclosure, not all the embodiments.

Therefore, detailed descriptions of the embodiments of the present disclosure are not intended to limit the scope of the present disclosure for which protection is requested, but represent only partial embodiments of the present disclosure. All other embodiments obtained by those of ordinary skill in the art based on the embodiments in the present disclosure without creative work shall fall within the protection scope of the present disclosure.

It should be noted that the embodiments in the present disclosure, and features and technical solutions in the embodiments may be combined with each other without conflicts.

It should be noted that similar reference signs and letters indicate similar items in the following drawings. Therefore, once a certain item is defined in one drawing, it is unnecessary to be further defined and explained in the subsequent drawings.

In the description of the present disclosure, it should be noted that orientations or positional relationships indicated by the terms “upper” and “lower” are orientations or positional relationships as shown based on the drawings, or orientations or positional relationships where this invention product are usually placed, or orientations or positional relationships that are usually understood by those skilled in the art, which are only for the purpose of facilitating and simplifying the description of the present disclosure instead of indicating or implying that devices or elements indicated must have particular orientations, and be constructed and operated in the particular orientations, so that these terms cannot be construed as limiting the present disclosure. In addition, the terms “first”, “second”, etc. are only for the purpose of distinguishing descriptions, and may not be understood as indicating or implying the relative importance.

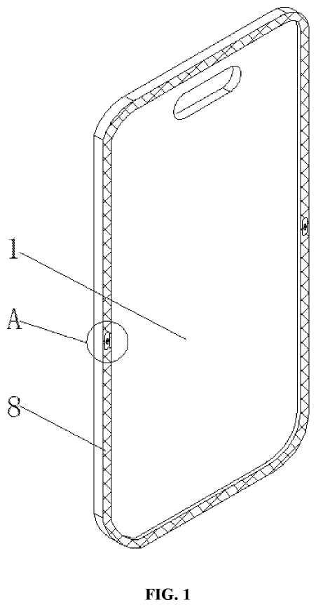

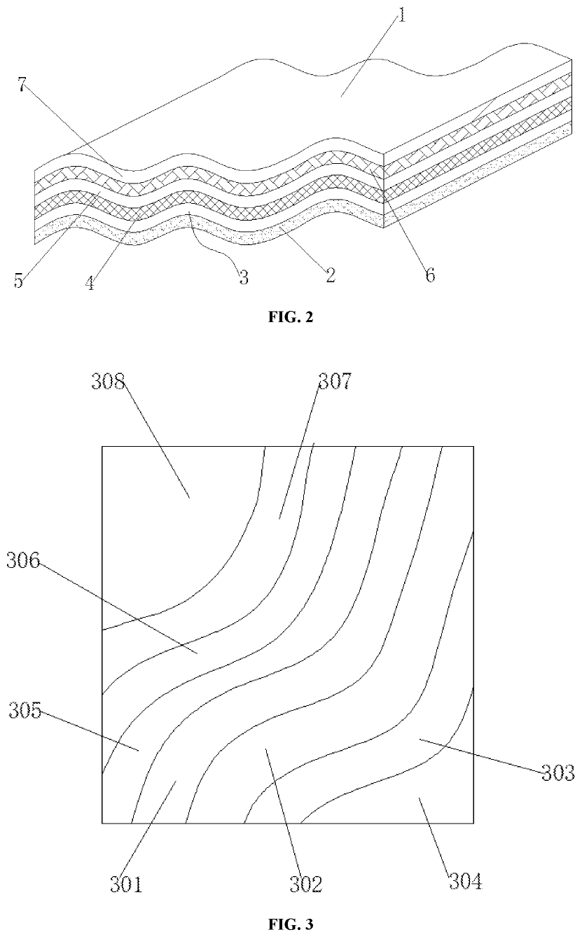

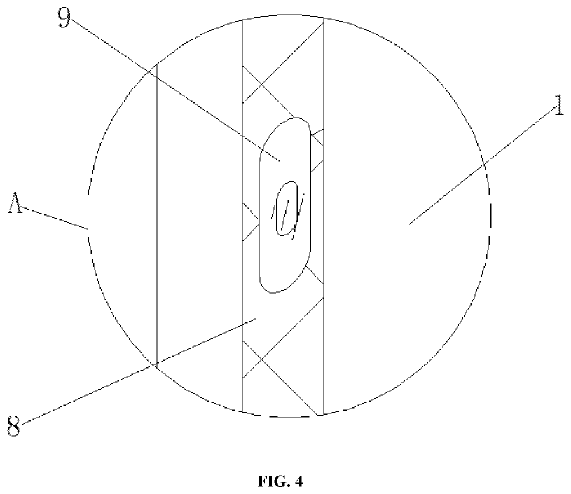

As shown in FIG. 1, FIG. 2, FIG. 3 and FIG. 4, this implementation provides a heat insulation and rejection protector, including a protector main body 1. A silica gel layer 2 is arranged on an outer wall of a bottom portion of the protector main body 1. A sunlight rejection PET layer 3 is arranged on an outer wall of one side of the silica gel layer 2. An OCA layer 4 is arranged on an outer wall of one side of the sunlight rejection PET layer 3. A silkscreen layer 5 is arranged on an outer wall of one side of the OCA layer 4. A glass board layer 6 is arranged on an outer wall of one side of the silkscreen layer 5. An AF hardness layer 7 is arranged on an outer wall of the glass board layer 6.

As shown in FIG. 1, FIG. 2 and FIG. 3, as a preferable implementation, based on the above manner, further, the sunlight rejection PET layer 3 includes a PET polyester substrate layer 301 arranged at a middle portion of the protector main body 1. A fixed viscose layer 302, an anti-oxidization isolation layer 303 and an anti-wear coating layer 304 are arranged on an outer wall of one side of the PET polyester substrate layer 301 in sequence. The outer wall of one side of the PET polyester substrate layer 301 is covered with a plurality of metal heat insulation film layers 305. An anti-ultraviolet isolation layer 306, a pressure-sensitive type viscose layer 307 and a transparent membranous protective layer 308 are arranged on an outer wall of one side of the metal heat insulation film layer 305 in sequence. The PET polyester substrate layer 301 is clear and transparent, and is a material with high durability, robustness, high toughness, moisture resistance, and high and low temperature resistance. This material ensures the firmness and toughness of a base layer of the mobile phone protector. The anti-wear coating layer 304 is a transparent anti-wear coating that ensures the wear resistance of the mobile phone protector. Because of the heat insulation film structure in the protector, one or more layers of metal materials (the metal heat insulation film layer 305) is added in the protector to reflect out infrared rays, thereby achieving the objective of heat insulation. Because it is mainly aimed at infrared heat insulation, the protector basically has a good heat insulation effect, and also has extremely high light transmittance. Heat insulation and safe light transmittance are both achieved.

As shown in FIG. 1 and FIG. 2, as a preferable implementation, based on the above, further, a thickness of the silica gel layer 2 is 45 μm: a thickness of the sunlight rejection PET layer 3 is 50 μm; a thickness of the OCA layer 4 is 80 μm/350 μm; a thickness of the silkscreen layer 5 is 8 μm; a thickness of the glass board layer 6 is 0.33/0.25 mm; and a thickness of the AF hardness layer 7 is 5 μm. It ensures the thickness of the overall combination of the mobile phone protector. The overall combination is relatively thin, which ensures that the mobile phone protector has good light transmittance.

As shown in FIG. 1, as a preferable implementation, based on the above, further, a cushioning rubber edge 8 is adhered to a peripheral outer wall of the protector main body 1. Due to the cushioning rubber edge 8 arranged around the protector, the protector will not be damaged due to an elastic support of the cushioning rubber edge 8 around the protector when a mobile phone falls down, which effectively prevents the mobile phone protector from being broken.

As shown in FIG. 1 and FIG. 2, as a preferable implementation, based on the above, further, cylindrical level bubbles 9 are inlaid in outer walls of two sides of the cushioning rubber edge 8. The cylindrical leveling bubbles 9 play a role in horizontal calibration during a bonding process of the mobile phone protector. After the mobile phone is bonded to the protector, the mobile phone has a horizontal measurement function due to the arrangement of the cylindrical leveling bubbles 9. During the use of the mobile phone, floating of bubbles in the cylindrical leveling bubbles 9 achieves a certain decorating effect.

Comparison of properties of the embodiments is as shown in the following table:

| | Visible | Total | Total | Total | Total |
|---|---|---|---|---|---|
| | light | solar energy | infrared ray | visible light | ultraviolet |
| | transmittance | rejection | rejection | rejection | ray rejection |
| | (%) | (%) | (%) | (%) | (%) |
| Heat insulation | 71 | 55 | 80 | 9 | 99 |
| and rejection | | | | | |
| protector | | | | | |
| Ordinary | 98.3 | 12 | 7.4 | 5 | 22.4 |
| transparent | | | | | |
| protector | | | | | |
| Anti-blue light | 84.1 | 28 | 8.8 | 8 | 100 |
| protector | | | | | |
| Automobile | 44 | 62 | 81 | 10 | 95 |
| color-changing | | | | | |
| film | | | | | |

In summary, the heat insulation and rejection protector has a better infrared rejection effect while maintaining good light transmittance, and has a better heat insulation characteristic compared to the traditional protector.

Specifically, when the heat insulation and rejection protector is in operation/use, because of the heat insulation film structure in the protector, one or more layers of metal materials (the metal heat insulation film layer 305) is added in the protector, thereby achieving extremely high heat insulation. In case of light wave irradiation, an electric field of light ways, free electrons absorb energy of the light and generate oscillation with the same frequency as that of the light, thereby emitting light with the same frequency as the original light, which is referred to as light reflection. A higher electrical conductivity of metal indicates shallower penetration and a higher reflectivity. Infrared rays will be reflected out to achieve the objective of heat insulation. Because it is mainly aimed at infrared heat insulation, the protector basically has a good heat insulation effect, and also has extremely high light transmittance. Heat insulation and safe light transmittance are both achieved. Due to the cushioning rubber edge 8 arranged around the protector, the protector will not be damaged due to an elastic support of the cushioning rubber edge 8 around the protector when a mobile phone falls down, which effectively prevents the mobile phone protector from being broken. The cylindrical leveling bubbles 9 play a role in horizontal calibration during a bonding process of the mobile phone protector. After the mobile phone is bonded to the protector, the mobile phone has a horizontal measurement function due to the arrangement of the cylindrical leveling bubbles 9. During the use of the mobile phone, floating of bubbles in the cylindrical leveling bubbles 9 achieves a certain decorating effect.

The above embodiments are only used to illustrate the present disclosure and not to limit the technical solutions described in the present disclosure. Although the present disclosure has been described in detail in this specification with reference to all the above embodiments, the present disclosure is not limited to the above specific implementations, so any modification or equivalent replacement of the present disclosure is made. All technical solutions and improvements that do not depart from the spirit and scope of the present disclosure all fall within the scope of the claims of the present disclosure.

What is claimed is:

1. A heat insulation and rejection protector, comprising a protector main body:
wherein a silica gel layer is arranged on an outer wall of a bottom portion of the protector main body, a sunlight rejection PET layer is arranged on an outer wall of one side of the silica gel layer, an OCA layer is arranged on an outer wall of one side of the sunlight rejection PET layer, a silkscreen layer is arranged on an outer wall of one side of the OCA layer, a glass board layer is arranged on an outer wall of one side of the silkscreen layer, and an AF hardness layer is arranged on an outer wall of the glass board layer.

2. The heat insulation and rejection protector of claim 1, wherein the sunlight rejection PET layer comprises a PET polyester substrate layer arranged at a middle portion of the protector main body, a fixed viscose layer, an anti-oxidization isolation layer and an anti-wear coating layer are arranged on an outer wall of one side of the PET polyester substrate layer in sequence, the outer wall of one side of the PET polyester substrate layer is covered with a plurality of metal heat insulation film layers, an anti-ultraviolet isolation layer, a pressure-sensitive type viscose layer and a transparent membranous protective layer are arranged on an outer wall of one side of the metal heat insulation film layer in sequence.

3. The heat insulation and rejection protector of claim 1, wherein the silica gel layer has a thickness of 45 um, the sunlight rejection PET layer has a thickness of 50 um, the OCA layer has a thickness of 80 um/350 um, the silkscreen layer has a thickness of 8 um, the glass board layer has a thickness of 0.33/0.25 mm, and the AF hardness layer has a thickness of 5 um.

4. The heat insulation and rejection protector of claim 1, wherein a cushioning rubber edge is adhered to a peripheral outer wall of the protector main body.

5. The heat insulation and rejection protector of claim 1, wherein cylindrical level bubbles are inlaid in outer walls of two sides of the cushioning rubber edge.
